(19) United States
(12) Patent Application Publication
(10) Pub. No.: US 2026/0263909 A1
(43) Pub. Date: Sep. 10, 2026

(54) PULLTAB-CARD COLLECTOR-AND-SCANNER

(71) Applicant: TECHNIK MFG., INC., Columbus, NE (US)

(72) Inventors: Douglas J Obal, Columbus, NE (US); Cody Wagner, Columbus, NE (US); Dennis K Wallen, Box Elder, SD (US); Robert Cemper, Columbus, NE (US); William L Sousan, Omaha, NE (US)

(73) Assignee: TECHNIK MFG., INC., Columbus, NE (US)

(21) Appl. No.: 19/074,050

(22) Filed: Mar. 7, 2025

(51) Int. Cl. A63F 3/06; G06Q 20/18; G06Q 50/34; G07F 17/32

(52) U.S. Cl. CPC A63F 3/064; A63F 3/069; G06Q 20/18; G06Q 50/34; G07F 17/3244

(57) ABSTRACT

A pulltab-card vending machine includes an integrated pulltab-card-collector-and-scanner device that enables players to automatically redeem their winning cards for credits toward the purchase of additional pulltab cards from the vending machine.

### FIELD OF TECHNOLOGY

The present disclosure generally relates to card-based games and lottery-type games, including collectible trading cards and pulltab games.

### BACKGROUND

“Pulltabs” (or “pull-tabs”) is an incredibly popular lottery-type game played in bars, pubs, breweries, and restaurants throughout the world. Known also by the names “pop-opens,” “break-opens,” and “pickle cards,” pulltabs involves a set of small cardboard cards (or “tickets”) available for purchase by customers of the hosting establishment. Often, a ticket booth staffed by a designated vendor (or “game operator”) manages sales of the cards, however, bartenders or other employees of the establishment can run the game as well. Typical pulltab cards include two or more cardboard layers coupled together—a bottom layer, featuring one or more randomized gaming entries; and a perforated top layer adhered overtop of the bottom layer to initially conceal the gaming entries. After purchase, the player can rip open a set of perforated strips (or “tabs”) on the top layer of the card in order to reveal the gaming entry concealed underneath. Upon revealing a “winning” gaming entry, the player can return the opened card to the vendor in exchange for a cash prize. Players often choose to use a portion of their cash prize to purchase additional pulltab cards to continue playing for potentially even greater rewards.

### SUMMARY OF THE INVENTION

Disclosed herein are various example systems, devices, and methods for automating certain aspects of a pulltab game, specifically, the ability to automatically redeem a winning pulltab card for credits toward the purchase of additional pulltab cards.

In some examples, a pulltab-card vending machine includes: a pulltab-card collector; a digital memory; and processing circuitry configured to: receive, from the pulltab-card collector, a prize-verification code indicative of a scanned barcode printed on a pulltab card; compare the prize-verification code to a set of game data stored in the digital memory; locate a matching entry for the prize-verification code within the game data and confirm that the matching entry has not already been redeemed; determine, based on the game data, a cash prize associated with the pulltab card; and apply a number of credits toward purchasing additional pulltab cards from the vending machine in an amount corresponding to the cash prize.

In some examples, a pulltab-card collector includes: a housing; a stepper motor; a drive belt configured to receive rotational motion from the stepper motor to draw a pulltab card into the housing; an optical scanner; a proximal sensor; a distal sensor; and processing circuitry configured to: receive, from the proximal sensor, a first signal indicating that the a pulltab card is positioned within the proximal sensor; responsive to receiving the first signal, activate the stepper motor to advance the pulltab card into the housing, and activate the optical scanner to scan an upper surface of the pulltab card; receive, from the distal sensor, a second signal indicative of the pulltab card positioned within the distal sensor; and responsive to receiving the second signal from the distal sensor, deactivate the stepper motor.

In some examples, a non-transitory, computer-readable medium encodes program instructions that, when executed by a processor of a pulltab-card collector, cause the processing circuitry to: receive, from a proximal sensor of the pulltab-card collector, a first signal indicative of a pulltab card positioned within the proximal sensor; responsive to receiving the first signal from the proximal sensor, activate a stepper motor to advance the pulltab card into the pulltab-card collector; responsive to receiving the first signal from the proximal sensor, activate an optical scanner configured to scan an upper surface of the pulltab card as the stepper motor advances the pulltab card into the pulltab-card collector; receive, from a distal sensor of the pulltab-card collector, a second signal indicative of the pulltab card positioned within the distal sensor; and responsive to receiving the second signal from the distal sensor, deactivate the stepper motor.

The aspects, features, advantages, benefits, and objects of the invention will become clear to those skilled in the art by reference to the following description, claims and drawings.

### BRIEF DESCRIPTION OF THE DRAWINGS

FIG. 1A is a partial-transparent perspective view of an example pulltab-card vending machine with an integrated pulltab-card collector-and-scanner.

FIG. 1B is a closeup front view of the pulltab-card vending machine of FIG. 1A.

FIG. 2A is a front-left-top isometric view of an example implementation of the pulltab-card collector of FIGS. 1A and 1B.

FIG. 2B is a front-end (or “proximal-side”) profile view of the pulltab-card collector of FIG. 2A.

FIG. 2C is a rear-end (or “back-side” or “distal-side”) profile view of the pulltab-card collector of FIGS. 2A and 2B.

FIG. 2D is a left-side profile view of the pulltab-card collector of FIGS. 2A-2C.

FIG. 2E is a right-side profile view of the pulltab-card collector of FIGS. 2A-2D.

FIG. 2F is a top view or overhead view of the pulltab-card collector of FIGS. 2A-2E.

FIG. 2G is a bottom view or underside view of the pulltab-card collector of FIGS. 2A-2F.

FIG. 3A is a front-right-top-perspective closeup view of a portion of the pulltab-card collector of FIGS. 2A-2G, illustrating an example pair of rollers therewithin.

FIG. 3B is a front-left-bottom-perspective closeup view of another portion of the pulltab-card collector of FIGS. 2A-2G, illustrating an example proximal optical sensor therewithin.

FIG. 4A is a proximal-end (or “front-side”) profile view of another example of the pulltab-card collector of FIGS. 2A-2G.

FIG. 4B is a perspective view of an upper housing panel and a pair of spring-biased rollers for the pulltab-card collector of FIG. 4A.

FIG. 5A is a front view of an example pulltab card from the vending machine of FIGS. 1A and 1B, having a set of perforated tabs in a “sealed” or “closed” configuration.

FIG. 5B is a front view of the pulltab card of FIG. 5A, with its perforated tabs in an “unsealed” or “open” configuration.

FIG. 6 is a conceptual block diagram of the pulltab-card vending machine of FIGS. 1A and 1B.

FIG. 7 is a spreadsheet depicting an example set of pulltab-game data that may be stored on the hard drive of the pulltab-card vending machine of FIGS. 1A and 1B.

FIG. 8 is a flowchart illustrating an example operation of the pulltab-card collector of FIGS. 1A and 1B.

FIG. 9 is a flowchart illustrating an example operation of the pulltab-card vending machine of FIGS. 1A and 1B.

### DETAILED DESCRIPTION

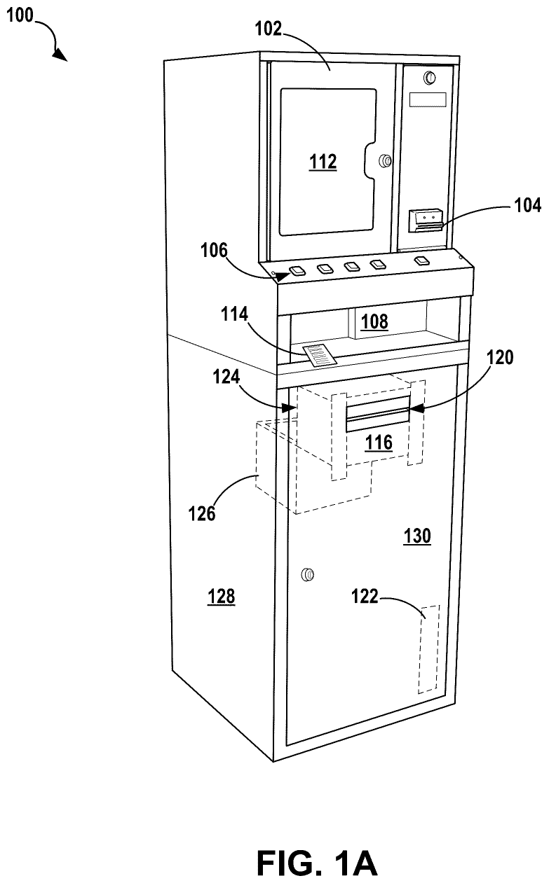

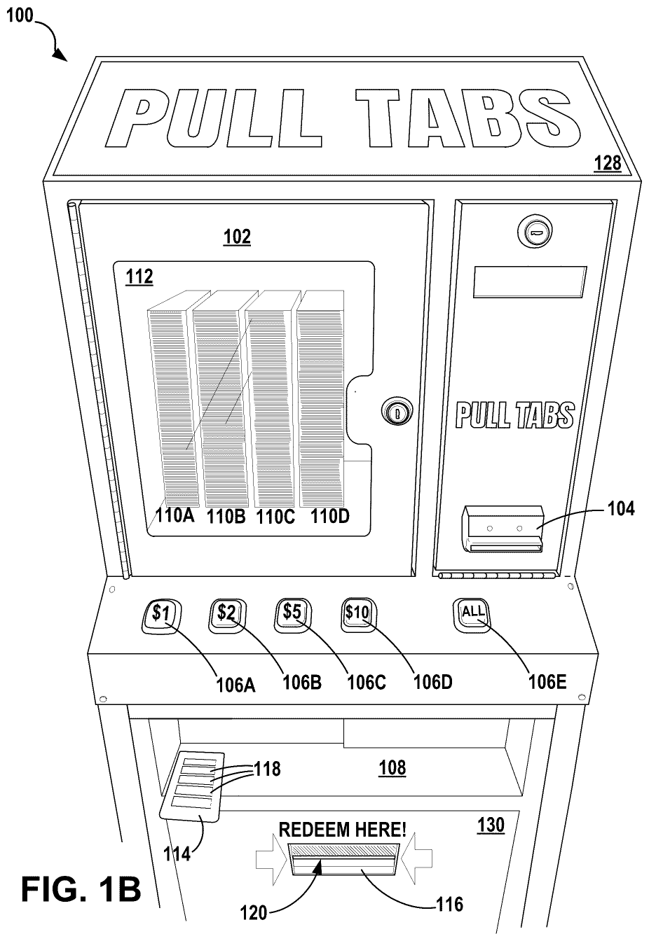

In general, the present disclosure is directed to systems, devices, and techniques for automating one or more aspects of a pulltab game, and in particular, the ability to automatically redeem a winning pulltab card for “credits” toward the purchase of additional pulltab cards from a pulltab-card vending machine. FIGS. 1A and 1B illustrate one such vending machine 100.

As shown in FIGS. 1A and 1B, pulltab-card vending machine 100 includes a lockable card safe 102, a cash-deposit slot 104, a plurality of selectable buttons 106A-106E, and a pulltab-card dispenser 108. In this example (but not all examples), lockable card safe 102 is configured to house four columns or stacks 110A-110D of pulltab cards, as viewed through transparent window 112. Each column or stack 110 corresponds to one of four different pulltab games running simultaneously. For instance, stack 110A includes pulltab cards available for $1 each, as indicated by button 106A. Stack 110B includes pulltab cards available for $2 each, as indicated by button 106B. Stack 110C includes pulltab cards available for $5 each, as indicated by button 106C. And stack 110D includes pulltab cards available for $10 each, as indicated by button 106D. In other examples, lockable card safe 102 can retain pulltab cards from more, fewer, or different games. For instance, in a different example, columns 110A and 110B could include pulltab cards from the same game, in which case buttons 106A and 106B would display the same dollar amount for purchase.

During use, a player initiates a transaction by depositing cash into the cash-deposit slot 104. In response to the vending machine 100 receiving cash through cash-deposit slot 104, one or more of buttons 106A-106D is configured to illuminate, indicating which stack(s) 110 of pulltab cards the player can select from. For instance, if the player deposited $5, then buttons 106A, 106B, and 106C would illuminate, but not button 106D, as the player did not deposit enough cash to purchase a $10 pulltab card from stack 110D. In that case, the player can select from any combination of buttons 106A-106C to purchase a number of pulltab cards collectively adding up to $5. As a few examples, the player could select button 106A five times; or the player could select button 106A three times and button 106B one time; or the player could select button 106C one time.

Vending machine 100 also includes an “ALL” button 106E. By selecting this button, the player indicates to vending machine 100 that they would like to select “all” of their cards from a common stack 110. For instance, rather than pressing button 106A five times in a row, the player could press the “ALL” button 106E, and then press button 106A, and vending machine 100 will automatically begin grabbing pulltab cards drawn from stack 110A, and dispensing each pulltab card 114 outward through card-dispensing area 108, until either (1) the player's cash deposit is spent, or (2) the player aborts the dispensing by pressing a different button 106. Other examples of vending machine 100 can include additional and/or different types of user-input devices other than pressable buttons 106, such as a digital touchscreen, a joystick, a scroll wheel, or any other suitable mechanism for indicating the player's card-stack selection to vending machine 100.

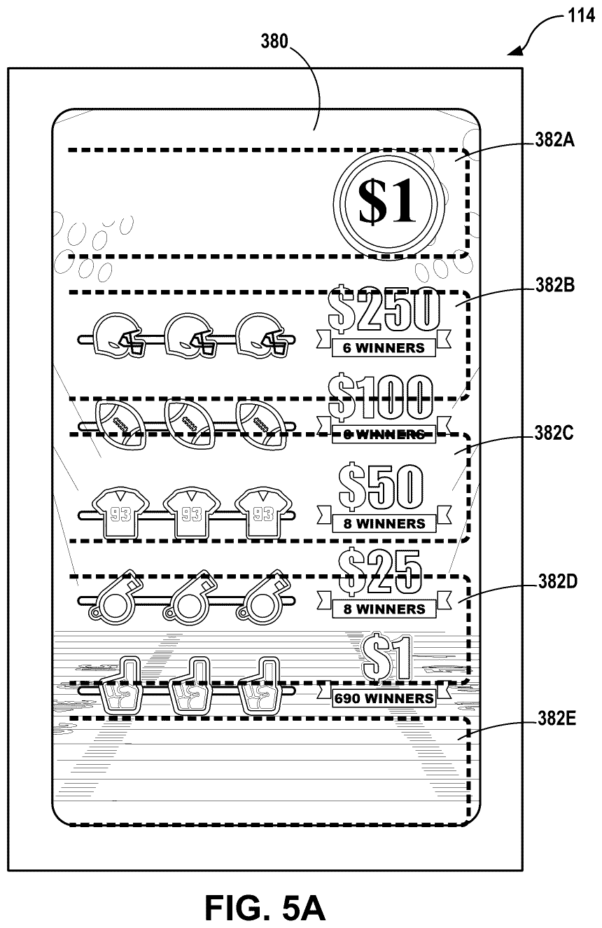

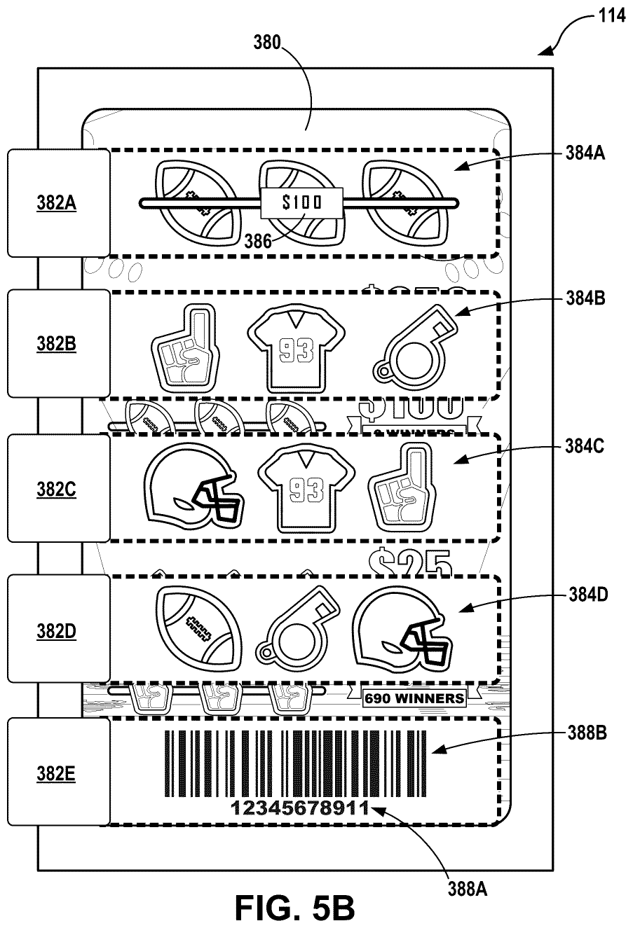

In accordance with the techniques of this disclosure, vending machine 100 further includes an integrated pulltab-card collector-and-scanner 116 (hereinafter, “card collector 116”). In general, card collector 116 is configured to automatically intake, scan, and securely retain pulltab cards that have been purchased and played (i.e., that have had their tabs 118 opened). For instance, a player can insert their pulltab card 114 into the proximal card slot 120, whereby the card collector 116 scans the card 114, attempting to detect a scannable “prize-verification code,” such as a barcode or Quick-Response (QR) code, printed on the card (see FIG. 5B).

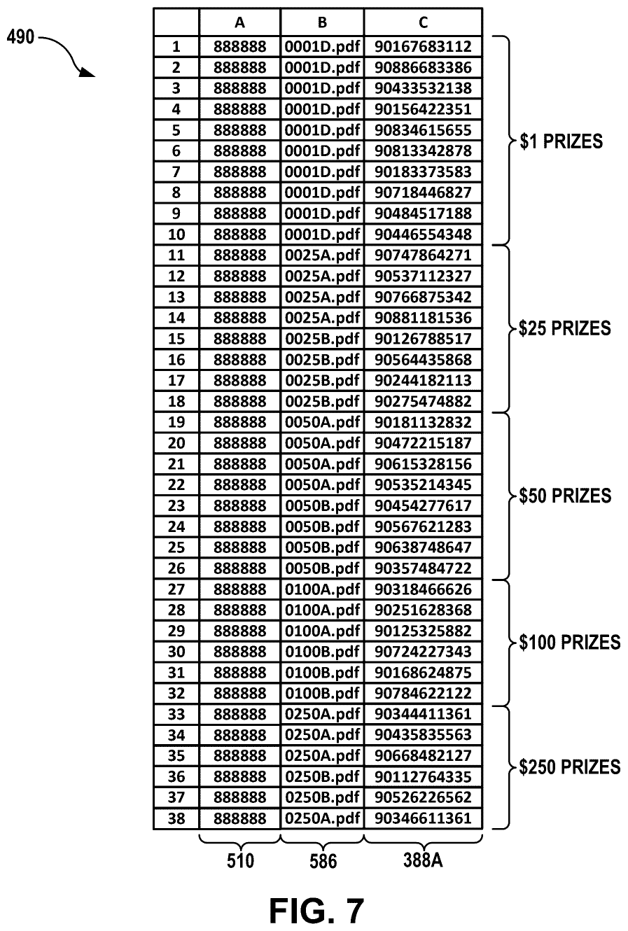

Upon successfully detecting and scanning a scannable code, the card collector 116 transmits the prize-verification code to the primary hard drive 122 of the vending machine 100 (or another communicatively-coupled computing device) to verify the code, based on a set of game data (see FIG. 7) stored on the hard drive 122.

In response to successfully validating the prize-verification code, the vending machine's hard drive 122 performs two actions. First, the hard drive 122 transmits a “verified” signal back to the card collector 116, causing the card collector 116 to further advance the pulltab card 114 until the card is ejected outward through a distal card slot 124 of the card collector 116. From there, the pulltab card 114 falls into a secure receptacle 126 located fully within the external housing 128 of the vending machine 100, i.e., where it cannot be retrieved by the player.

Second, the vending-machine hard drive 122 ascertains, based on the game data stored in memory, a cash prize associated with the winning pulltab card 114, and activates a number of internal “credits” corresponding to the cash prize. For instance, if winning pulltab card 114 had a cash prize of $10, then the hard drive 122 would cause the vending machine 100 to behave as if the player had deposited $10 cash into cash-deposit slot 104, i.e., allowing the player to select $10 worth of additional pulltab cards to be released via dispenser 108.

Conversely, if the card collector 116 does not detect a scannable prize-verification code printed on the pulltab card 114 before the leading edge of the card 114 reaches the distal side of the card collector 116, then the collector 116 “rejects” the pulltab card 114 by ejecting the card back out through the proximal slot 120. Similarly, if the card collector 116 detects a scannable code on the pulltab card 114, but the vending machine's hard drive 122 fails to verify the code based on the game data stored in memory, then the hard drive 122 transmits an “unverified” signal back to the card collector that causes the card collector 116 to eject the pulltab card 114 back out through the proximal slot 120.

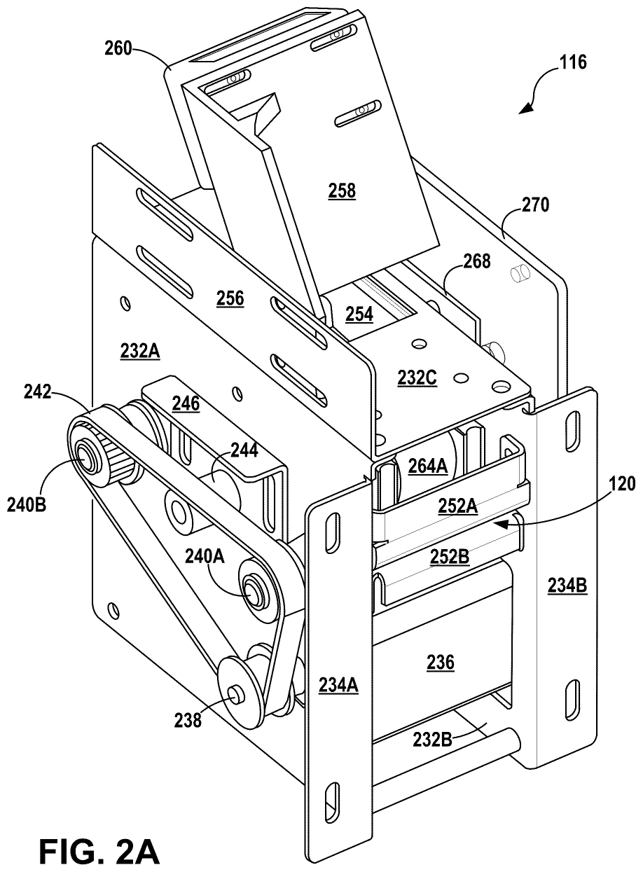

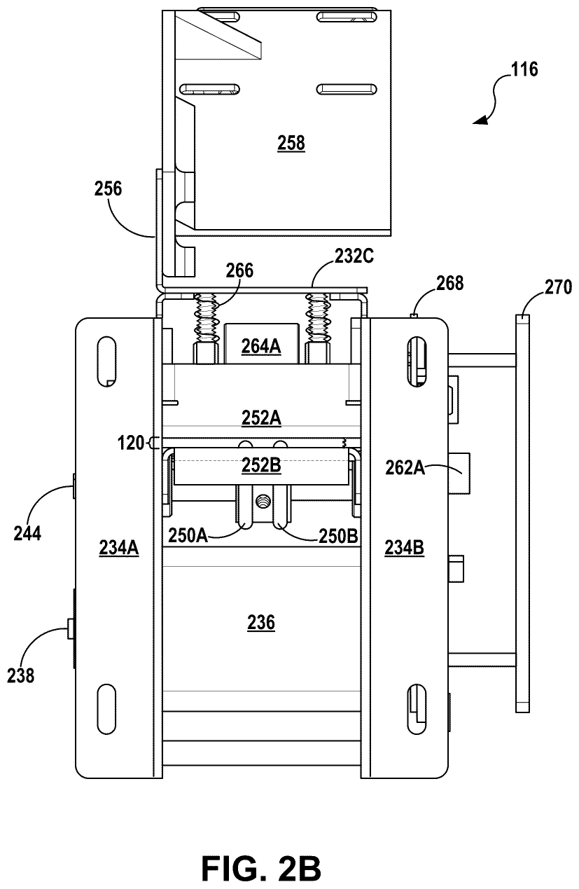

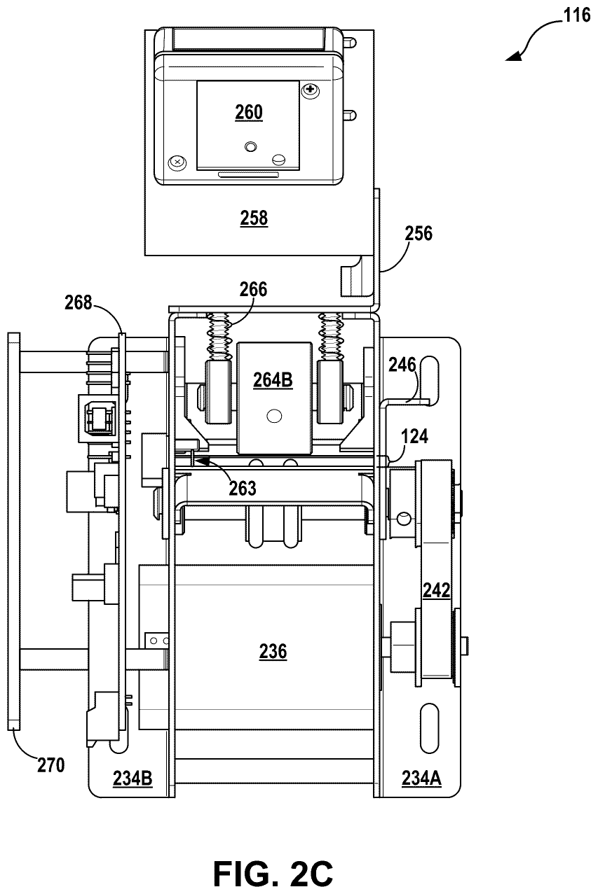

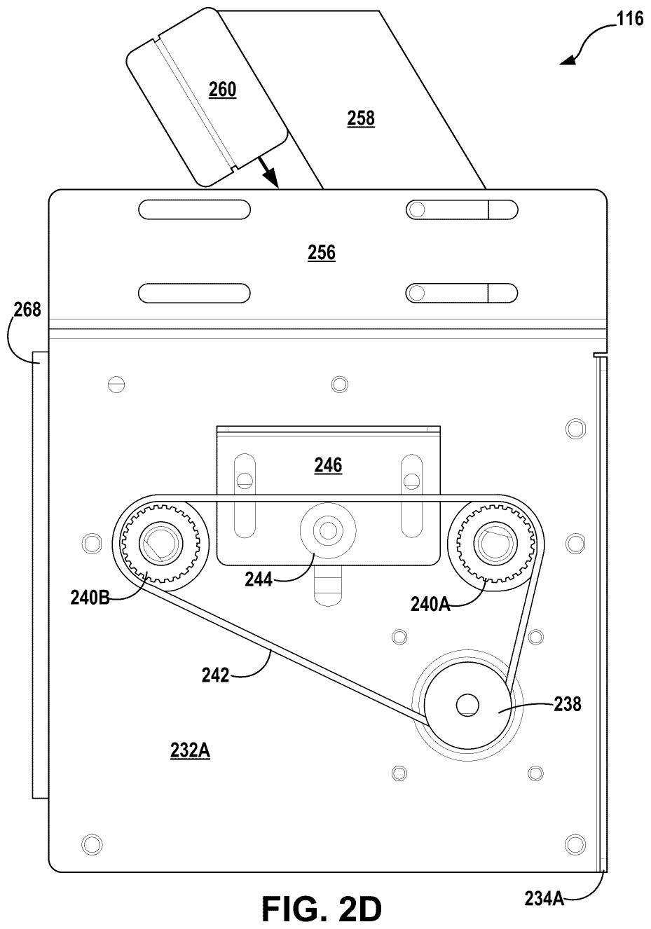

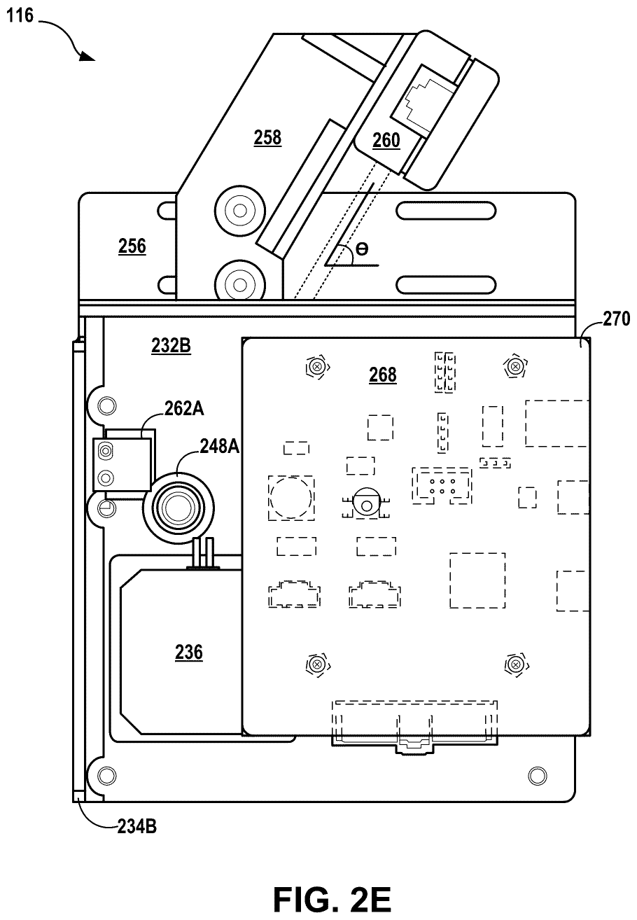

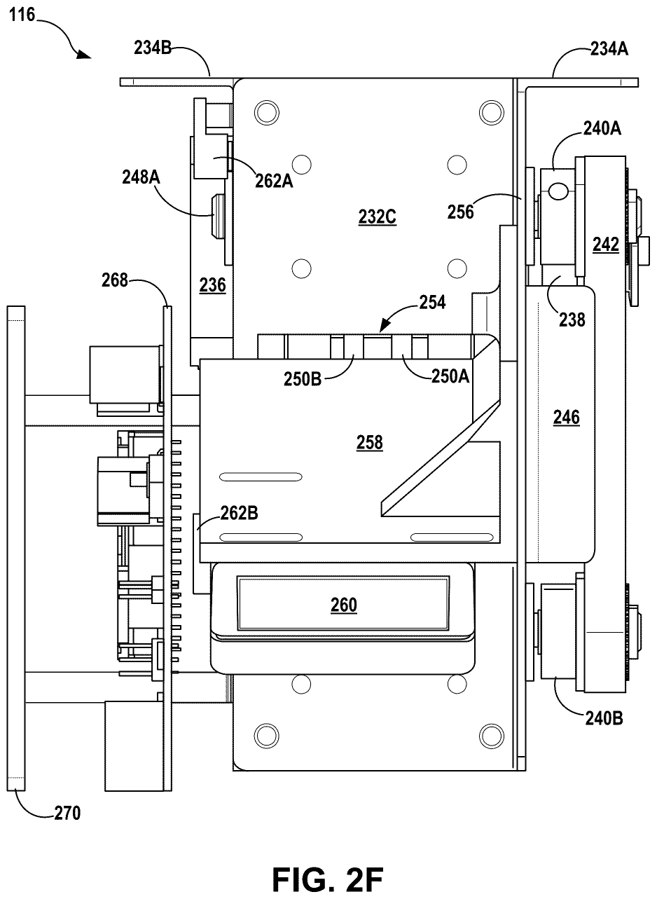

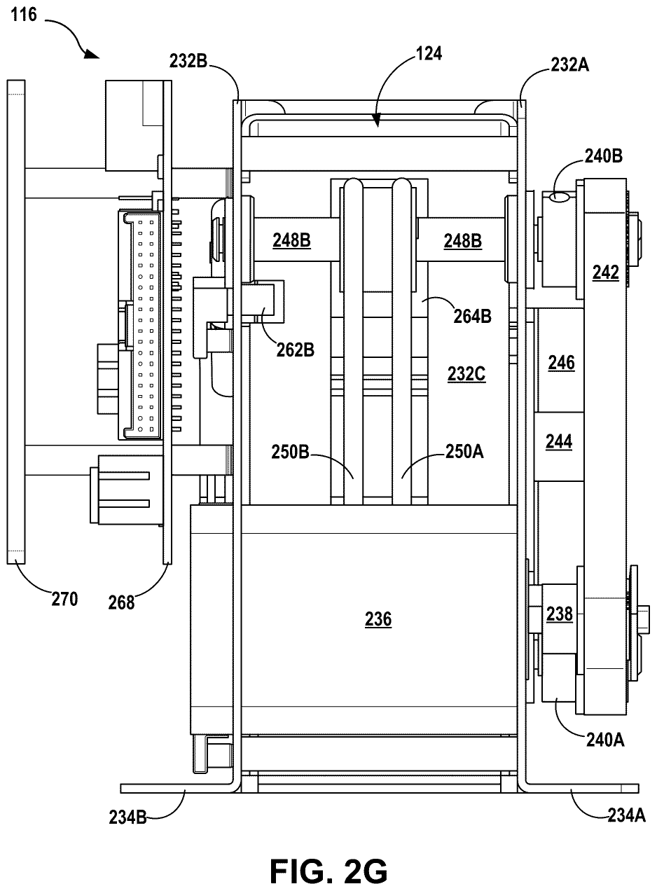

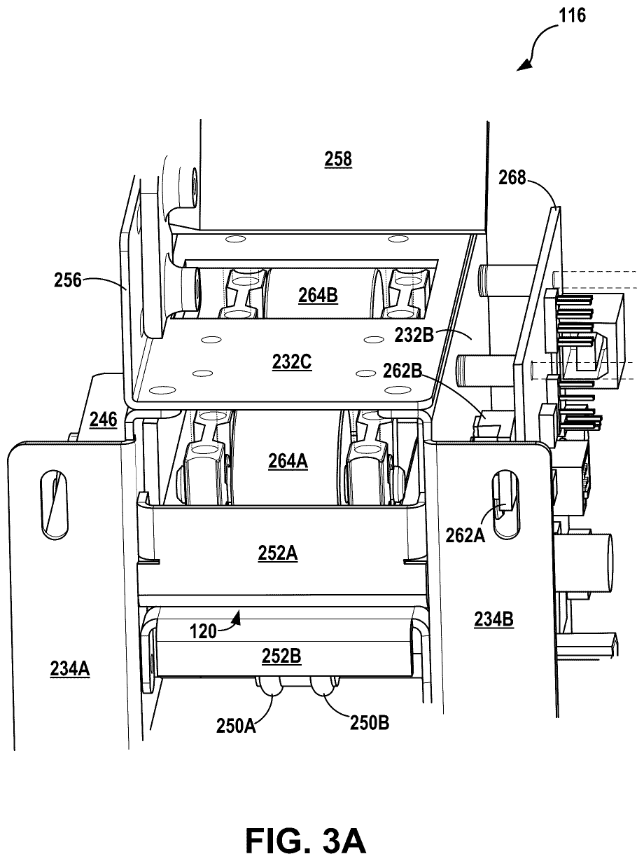

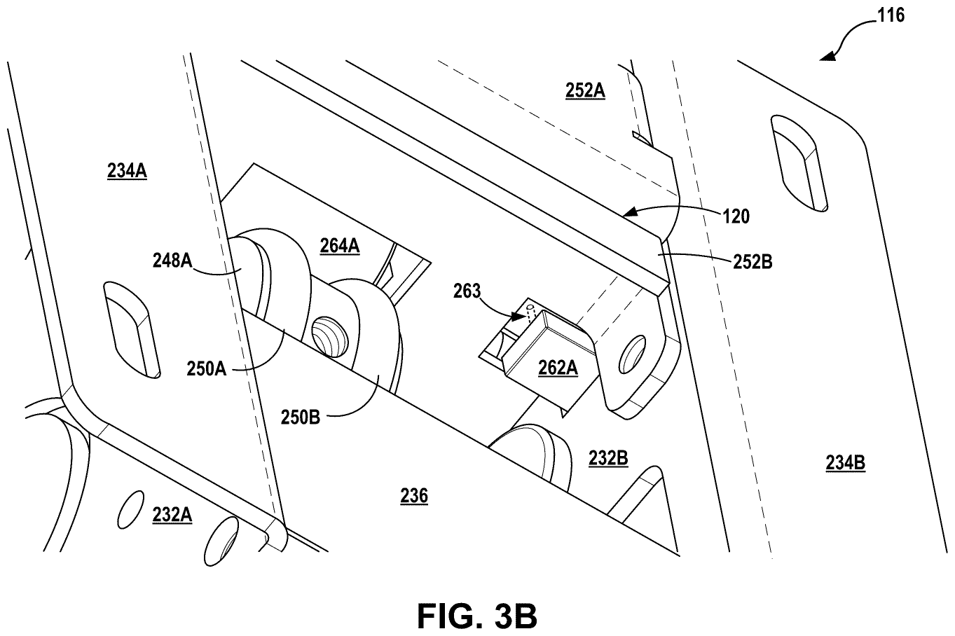

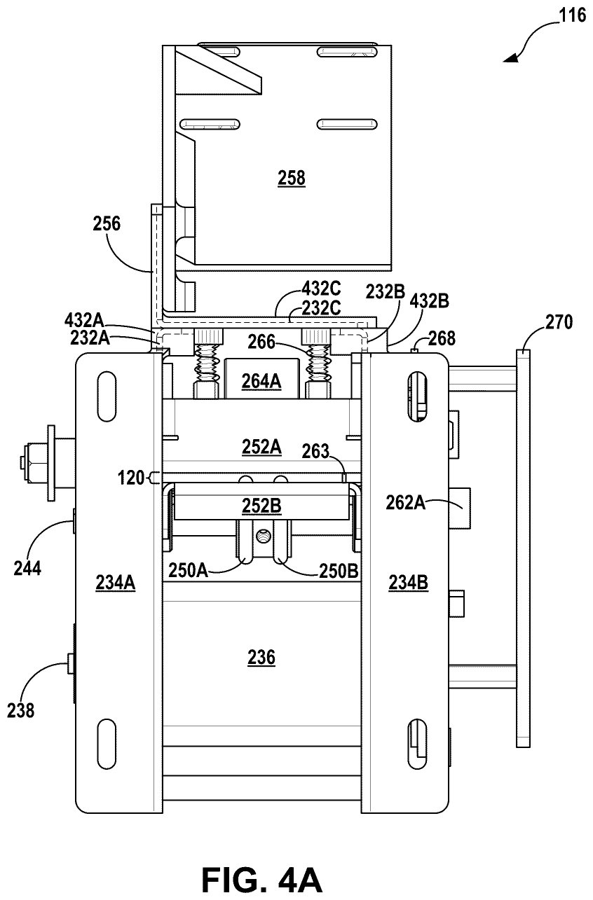

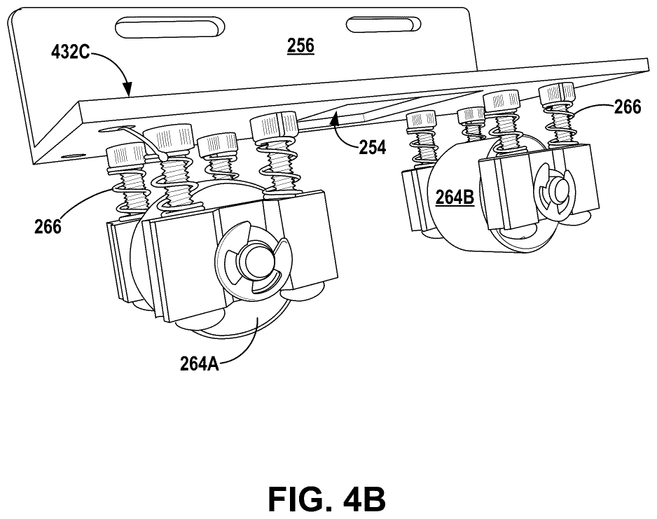

FIGS. 2A-2G illustrate a first non-limiting example implementation of the pulltab-card collector 116 of FIGS. 1A and 1B. As shown, the card collector 116 features a rigid structural framework or housing 232, including (at least) a left-side panel 232A, a right-side panel 232B, and an upper panel 232C. The housing 232 may be formed from any suitably durable material capable of retaining the other sub-components of card collector 116 in fixed positions relative to one another. For instance, in the example implementation of FIGS. 2A-3B, the pulltab-card collector 116 is depicted as having a housing 232 formed from metal, such as a cold-roll metal (e.g., steel) with a protective coating (e.g., galvanneal). In other examples, such as the example implementation of FIGS. 4A and 4B, the housing 232 (432) may be formed primarily from a plastic material, for instance, when the housing panels are 3-D-printed (e.g., PLA plastic) or injection-molded. In yet other examples, the panels of housing 232 may be formed from a combination of metal, plastic, and/or other materials.

The pulltab-card collector 116 is configured to be firmly mounted in a fixed location within the interior of the vending machine's housing 128. For instance, in the present example, the card collector 116 is configured to be mounted onto the interior surface of a lockable proximal door (or “front door”) 130 (FIGS. 1A and 1B) of the vending machine's housing 128. Accordingly, as shown in FIGS. 2A-2G, the card collector 116 includes a pair of proximal (or “front”) mounting brackets 234A, 234B, positioned on opposite lateral sides of proximal card slot 120.

Within the housing 232, the card collector 116 includes a stepper motor 236 having a driveshaft 238 that extends through the left-side housing panel 232A. One non-limiting example of a suitable stepper motor 236 is the “Model 17HS24-2104S” stepper motor available from StepperOnline Inc., headquartered in New York City, New York.

The stepper-motor driveshaft 238 is rotatably coupled to a proximal gear 240A and a distal gear 240B via a drive belt 242. In some examples, the card collector 116 further includes a tension rod 244 extending outward from a tension-rod mounting plate 246 adjustably (e.g., slidably) coupled to the left-side panel 232A. Adjusting the tension plate 246 up or down relative to left-side panel 232A causes the tension rod 244 to apply less tension or more tension, respectively, to the interior or exterior of the drive belt 242. This mechanism can be used to “lock” the belt 242 in place, or to release the belt 242 when in need of replacement. Additionally, the mechanism can be used to calibrate the rotational relationship between the driveshaft 238 and the proximal and distal gears 240A, 240B.

The proximal gear 240A is coaxially coupled to a proximal axle 248A, and the distal gear 240B is coaxially coupled to a distal axle 248B. A uniquely tailored feed belt 250, including a “left” friction band 250A and a “right” friction band 250B, extends around the proximal and distal axles 248A/248B, similar to how the drive belt 242 extends around the proximal and distal gears 240A/240B. The high-friction feed belt 250 is configured to “grab” onto the underside of a pulltab card 114 (FIGS. 1A and 1B) to pull the card 114 into, or push the card 114 out of, the card collector 116. Accordingly, the friction bands 250A/250B should be formed from a high-friction, rubber-like material. An illustrative, non-limiting example of one such high-friction material is Compound WN70, available from The O-Ring Store, LLC, of Clarkston, Washington. Feed belts formed from Compound WN70 can be considered to be highly chemical resistant, ultraviolet (UV) radiation resistant, and oil resistant, as well as food-grade-certified under the Food & Drug Administration (FDA), collectively providing for substantial durability over the useful lifespan of the feed belt 250.

Toward the proximal side of the card collector 116 (shown best in FIG. 2B), the card collector 116 includes an upper card-intake guide 252A and a lower card-intake guide 252B, mutually defining the proximal card-intake slot 120 therebetween.

As viewed best in the “overhead” view of FIG. 2F, The upper housing panel 232C of card collector 116 defines a large rectangular scanning aperture 254 through which the interior of housing 232 may be viewed. The right-most side of upper panel 232C bends 90° upward to form an intermediary scanner-mounting bracket 256. Removably coupled to the intermediary scanner-mounting bracket 256 is a primary scanner-mounting bracket 258. Removably coupled to the primary scanner-mounting bracket 258 is an optical scanner 260 configured to detect a scannable prize-verification code (e.g., a barcode or QR code) printed on a pulltab card 114 while the pulltab card 114 is “visible” through the upper scanning aperture 254. One non-limiting example of a suitable optical scanner 260 is the “Model DE33 Enclosed 2-D Embedded Barcode Scan Module,” available from Diamond Technologies of Hudson, Massachusetts.

Specifically, the scanner-mounting bracket 258 is configured to adjustably retain the optical scanner 260 at a desired orientation relative to the internal components of the card collector 116. For instance, by adjusting the orientation of the scanner-mounting bracket 258 relative to the intermediary scanner-mounting bracket 256, the user can precisely control the angle “Θ” (FIG. 2E) at which the optical scanner 260 “looks” into the interior of the housing 232 through the scanning aperture 254. In general, this angle Θ can be configured anywhere between about 45° and about 135°, as desired by the user. In practice, it has been found that angles close to 90x, i.e., facing directly downward, perpendicular to the surface of the pulltab card 114, can induce a reflective glare off the surface of the card that can reduce the success rate in scanning the card. Accordingly, a mounting angle Θ between about 50° and about 70° (preferably around 60°) seems to significantly increase scanning functionality. The angle-adjustment mechanism remains available for further calibration, as needed.

The card collector 116 further includes a proximal optical sensor 262A (as best seen in the closeup view of FIG. 3B), and a distal optical sensor 262B (as best seen in the underside view of FIG. 2G). In general, each optical sensor 262A/262B is configured to detect the presence of a pulltab card 114 positioned within the “field-of-view” (FOV) of the respective sensor. For instance, each sensor 262A/262B can include an optical emitter-receiver pair, such that the sensor 262A/262B is triggered when a pulltab card 114 positioned between the emitter and receiver prevents the receiver unit from detecting an “expected” optical signal 263 (FIGS. 2C and 3B), such as a laser pulse, from the emitter unit. One non-limiting example of a suitable optical sensor is the Model EE-SX3173 Photomicrosensor, available from Omron Corporation of Kyoto, Japan. In some examples, but not all examples, the card collector 116 includes an additional guide member (not shown) along the left-side panel 232A within the card-intake slot 120 to help direct the pulltab card 114 over toward the optical scanners 262A/262B along the right-side panel 232B, particularly when the pulltab card 114 is lightly crumpled or otherwise deformed.

Upon inserting a pulltab card 114 into the proximal card-intake slot 120, the leading edge of the card 114 triggers the proximal optical sensor 262A, causing the stepper motor 236 to activate to withdraw the card 114 into the interior of the housing 232 where the upper surface of the card 114 is scanned by the optical scanner 260 through the upper viewing aperture 254. If the optical scanner 260 has not yet detected a scannable code on the surface of the card 114 by the time the leading edge of the card 114 triggers the distal sensor 262B, the control panel reverses the stepper motor 236 to eject the card 114 back out through the proximal slot 120. If a scannable code has been successfully detected, the control panel continues to drive the stepper motor 236 forward to eject the card 114 out the distal slot 124 (FIG. 2C) and into a secure receptacle 126 (FIG. 1A) within the interior of the vending machine 100.

As best viewed in FIGS. 3A and 4B, in some examples, in addition to the (lower) proximal and distal rotating axles 248A/248B, the card collector 116 further includes a pair of (upper) proximal and distal rollers 264A, 264B configured to rotate freely against the top surface of the pulltab card 114 to help guide the card into an “ideal” path of motion underneath the optical scanner 260. In some such examples, the card collector 116 further includes sets of springs 266 configured to bias the rollers 264 downward against the upper surface of the pulltab card 114. By including spring-loaded (i.e., variable-height) rollers 264, rather than fixed-axis rollers at a predetermined height above the feed belt 250, the card collector 116 is able to accept pulltab cards in a wide range of different thicknesses (e.g., from about 0.005 inches thick to about 0.100 inches thick) without jamming the feed belt 250 or otherwise becoming stuck.

Mounted to the exterior of the right-side housing panel 232B/432B, the card collector 116 further includes an electronic control board 268 and protective cover 270. Control board 268 includes highly specialized firmware configured to enable the functionality of the card collector 116. An example operation of control board 268, as governed by the custom firmware, is as follows:

Control board 268 receives a “first” signal from proximal optical sensor 262A, indicating that a pulltab card 114 has been inserted into proximal card slot 120. In response, the control board 268 activates the stepper motor 236, which causes feed belt 250 to drag the pulltab card 114 into the interior of housing 232. Simultaneously, control board 268 activates the optical scanner 260 to scan the upper surface of pulltab card 114 through the scanning aperture 254.

Upon receiving a scannable prize-verification code from the optical scanner 260, the control board 268 transmits the prize-verification code to the hard drive 122 of the vending machine 100 within which card collector 116 is installed. Control board 268 then waits to receive either a “verified” indication or an “unverified” indication from hard drive 122.

Upon receiving a “verified” indication from the hard drive 122, the control board 268 allows the stepper motor 236 to continue to advance the pulltab card 114 forward and outward through the distal card slot 124. The stepper motor 236 remains active until control board 268 stops receiving a second signal from the distal sensor 262B, indicating that the pulltab card 114 has been fully ejected from card collector 116 and is no longer blocking the sensor's photodetector. In response, control board 268 deactivates the stepper motor. Meanwhile, the vending machine's hard drive 122 awards the winning pulltab card's cash prize in the form of credits toward the purchase of additional pulltab cards from vending machine 100.

Upon receiving an “unverified” indication from hard drive 122, control board 268 immediately reverses the stepper motor 236 in order to drive pulltab card 114 backward and outward through the proximal card slot 120. The stepper motor 236 remains active until control board 268 stops receiving the first signal from the proximal sensor 262A, indicating that the pulltab card 114 has been fully ejected from card collector 116 and is no longer blocking the sensor's photodetector. In response, the control board 268 deactivates the stepper motor 236.

Similarly, if the control board 268 fails to receive any prize-verification code from the optical scanner 260 by the time the leading edge of the pulltab card 114 triggers the distal sensor 262B, then the control board 268 reverses the stepper motor 236 in order to drive the pulltab card 114 backward and outward through the proximal card slot 120. The stepper motor 236 remains active until the control board 268 stops receiving the first signal from the proximal sensor 262A, indicating that the pulltab card 114 has been fully ejected from the card collector 116 and is no longer blocking the sensor's photodetector. In response, the control board 268 deactivates the stepper motor 236.

In some examples, the control board 268 provides additional functionality and control over the card collector 116. For instance, in certain versions, the custom firmware running on the control board 268 enables the user to run the stepper motor 236 at different predetermined selectable speeds, e.g., for different types of pulltab cards, or according to user preference. In one example, the control board 268 provides for selection between a “low” setting of stepper motor 236 (e.g., around 60 rpm) and a “high” setting of stepper motor 236 (e.g., around 180 rpm).

As referenced above, the panels of the housing 232 (432) can be formed from virtually any suitable material. However, for different materials, certain alterations may be required in order to compensate for variations in physical properties. As an illustrative example, FIG. 4A shows a conceptual “overlay” diagram of the pulltab-card collector 116 having a plastic-based housing 432 (in solid lines), with the metal-based housing 232 from FIG. 2B drawn overtop (in dashed lines) for comparison. As shown, the panels 432A/432B/432C of a plastic-based housing 432 may need to be fabricated (e.g., 3-D-printed, etc.) to be marginally thicker than the panels 232A/232B/232C of a metal-based housing 232 in order to maintain a comparable structural integrity.

FIGS. 5A and 5B depict an illustrative, non-limiting example of a pulltab card 114 that may be dispensed from vending machine 100 of FIGS. 1A and 1B. Pulltab card 114 of FIGS. 5A and 5B is one example of such a card belonging to a larger set of pulltab cards 110 (FIG. 1B) associated with a common pulltab game.

As shown in FIGS. 5A and 5B, the outer surface 380 of pulltab card 114 defines one or more perforated tabs 382A-382E. In this non-limiting example, outer surface 380 defines five vertically aligned perforated tabs 382; other examples of pulltab card 114 can include more than five tabs or fewer than five tabs 382, as desired.

In the example shown in FIG. 5B, the player has ripped open all five perforated tabs 382A-382E, revealing one or more pulltab-game entries 384A-384D, with each game entry 384 strategically positioned underneath a respective perforated tab 382A-382D.

For instance, upon tearing open the first perforated tab 382A, the player discovers that the game entry 384A concealed underneath the tab 382A includes a particular sequence of icons (depicted here as three consecutive football-shaped icons), which, under the rules of the corresponding pulltab game, constitutes a winning game entry 384—thus, pulltab card 114 is a winning card.

Additionally, winning pulltab card 114 features a numerical cash-prize indication 386 overtop of the winning game entry 384A (or, in other examples, overtop of a different (non-winning) game entry 384B-384D on the same card 114).

Even further, the winning card 114 is designated with a unique identifier—a “prize-verification code”—enabling automation of a subsequent portion of the game in which the player redeems their winning card 114 for credits toward the purchase of additional pulltab cards. In FIG. 5B, this unique identifier is strategically concealed beneath the fifth perforated tab 382E, and includes both a numeric (or alphanumeric) prize-verification code 388A, and a machine-scannable prize-verification code 388B, such as a barcode, QR code, etc., that digitally encodes the prize-verification code 388A.

In the example shown, numeric prize-verification code 388A and scannable verification code 388B occupy the space that would otherwise be occupied by a fifth game entry. But since pulltab card 116 is already a winning card, game entries other than the winning game entry 384A are not necessary to be included on the same card.

Prize-verification code 388A is shown in FIG. 5B as an eleven-digit numeric sequence, although other sequences are also contemplated, such as a twelve-digit numeric sequence or a six-or-seven character alphanumeric sequence (as just three examples).

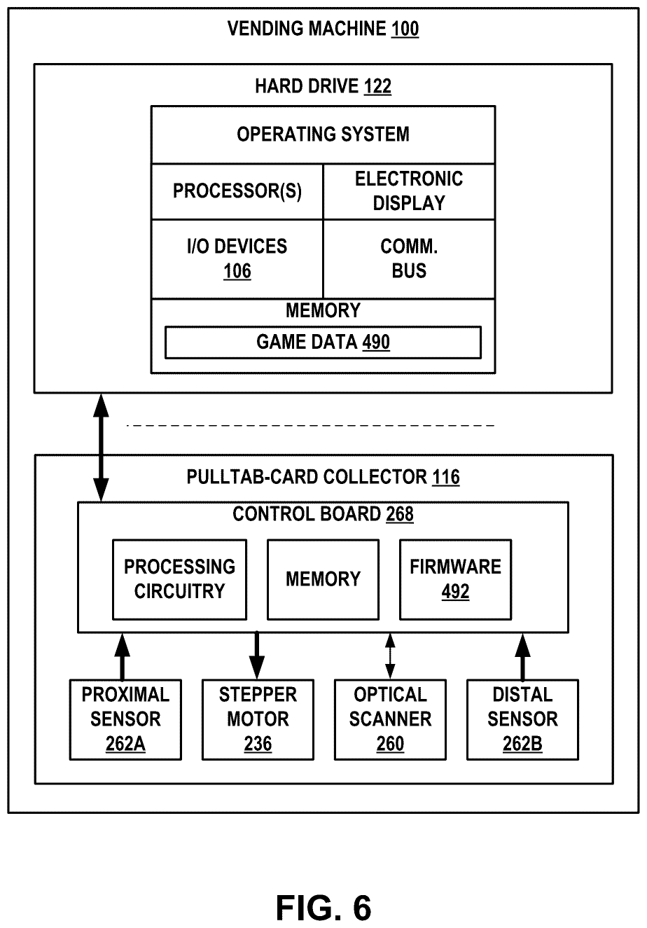

FIG. 6 is a conceptual block diagram of an example computer architecture for the pulltab-card vending machine 100 of FIGS. 1A and 1B, highlighting some functional relationships between various electronic sub-components thereof. The vending machine's hard drive 122 and/or the card collector's control board 268 can include volatile and/or non-volatile memory, such as random-access memory (RAM) and read-only memory (ROM), as well as one or more processing devices (e.g., central processing units (CPUs), graphical processing units (GPUs), and the like). As needed to implement the functionality described herein, the vending machine 100 can include various media devices, such as a hard-disk module, an optical-disk module, and so forth. The vending machine 100 may perform any of all of the computer-based operations (e.g., optical scanning and data-processing) described throughout this disclosure by processing device(s) executing instructions stored in memory (e.g., RAM, ROM, and the like).

More generally, instructions and other program information may be stored on any computer-readable medium, including, but not limited to, static-memory storage devices, magnetic storage devices, and optical storage devices. The term “computer-readable medium” also encompasses plural storage devices. In all cases, a computer-readable medium represents some form of physical and tangible entity. By way of example and not limitation, a computer-readable medium may comprise storage media (e.g., RAM, ROM, EEPROM, Flash memory, or other memory technology, CD-ROM, digital versatile disks (DVD) or other optical storage, etc.) and/or communications media (e.g., wired media such as wired network or direct-wired connection, and wireless media such as acoustic, RF, infrared, and other wireless media).

The vending machine 100 includes an input/output (I/O) module 106, such as push buttons, for receiving various inputs (via input modules), and for providing various outputs (via one or more output modules). The vending machine 100 may also include one or more network interfaces for exchanging data with other devices via one or more communication conduits. In some aspects, one or more communication buses communicatively couple the above-described components together.

Communication conduit(s) may be implemented in any manner, such as via a local-area network (LAN), a wide-area network (WAN, e.g., the Internet), and the like, or any suitable combination thereof. Communication conduit(s) may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components, such as Field-Programmable Gate Arrays (FPGAs), Application-Specific Integrated Circuits (ASICs), Application-Specific Standard Products (ASSPs), Systems-on-a-Chip (SOCs), Complex Programmable Logic Devices (CPLDs), and the like.

FIG. 7 is a spreadsheet illustrating an example set of game data 490 that could be uploaded to the hard drive 122 of pulltab-card vending machine 100 for verifying winning pulltab cards. In this example, game data 490 is formatted as a Comma-Separated Values (“.csv”) file with at least three distinct data parameters (i.e., columns) for each entry (i.e., row), wherein each entry/row represents a different winning pulltab card.

In this particular example, column “A” contains a unique “game serial number” 510 assigned to each pulltab game (i.e., to each stack of pulltab cards 110, in FIG. 1A), which, in this example, is “888888.” Column “B” contains a “denomination code” 586 (e.g., prize-amount indicator 386 of FIG. 5B), i.e., a monetary value, in units of U.S. dollars, of the cash prize for the winning pulltab card represented by that particular row. For instance, in the value “0001D.pdf,” the number “0001” represents a prize amount of $1, and the letter “D” indicates which game entry 384 (e.g., the fourth game entry 384D concealed underneath the fourth perforated tab 382D) was the winning game entry on the card 114. Finally, column “C” contains the numeric prize-verification code 388A for a winning pulltab card 114 (which is also encoded by the scannable code 388B), in order to associate the other two columns with one particular winning card.

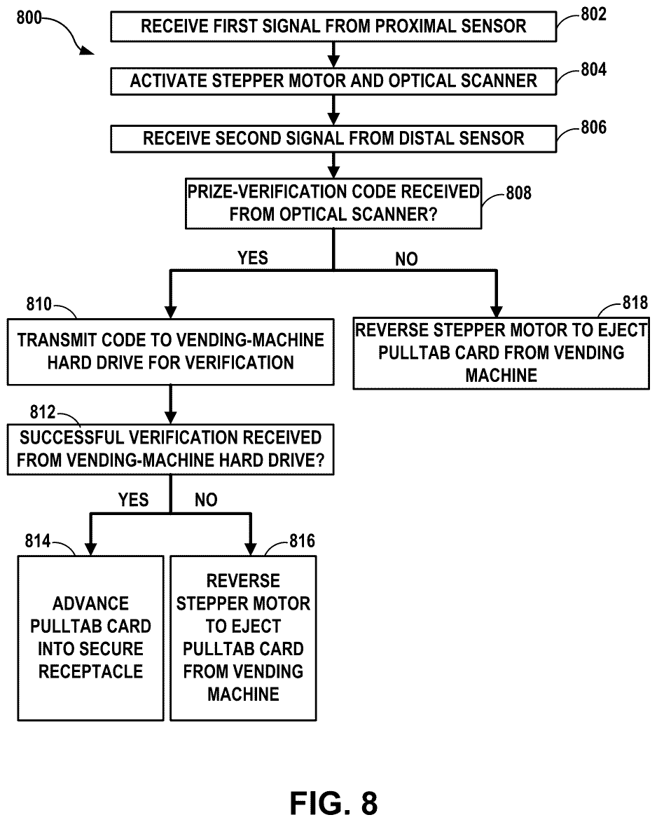

FIG. 8 is a flowchart 800 illustrating an example operation performed by the control board 268 of a pulltab-card collector 116. First, at Step 802, control board 268 receives a “first” signal from proximal optical sensor 262A, indicating that a pulltab card 114 has been inserted into proximal card slot 120. In response, at Step 804, control board 268 activates a stepper motor 236, which causes feed belt 250 to drag pulltab card 114 into the interior of housing 232. Simultaneously, control board 268 activates optical scanner 260 to scan the upper surface of the pulltab card 114.

Subsequently, at Step 806, control board 268 receives a “second” signal from distal optical sensor 262B, indicating that the pulltab card 114 has reached the distal card slot 124 and is now fully contained within the housing 232, and positioned underneath the optical scanner 260 through the scanning aperture 254. In response, at Step 808, control board 268 determines whether it has received a valid, scanned prize-verification code on the surface of the pulltab card 114 from the optical scanner 260 prior to this point.

Upon receiving such a code from the optical scanner 260 (“YES” branch from Step 808), at Step 810, the control board 268 transmits the prize-verification code to the hard drive 122 of the vending machine 100 within which card collector 116 is installed. At Step 812, the control board 268 receives either a “verified” indication or an “unverified” indication from hard drive 122.

Upon receiving a “verified” indication from hard drive 122 (“YES” branch from Step 812”), at Step 814, the control board 268 allows the stepper motor 236 to continue to advance the pulltab card 114 forward and outward through distal card slot 124. The stepper motor 236 remains active until the control board 268 stops receiving a second signal from the distal optical sensor 262B, indicating that the pulltab card 114 has been fully ejected from card collector 116 and is no longer blocking the sensor's photodetector. In response, the control board 268 deactivates the stepper motor. Meanwhile, the vending machine's hard drive 122 awards the winning pulltab card's cash prize in the form of credits toward the purchase of additional pulltab cards from vending machine 100.

Upon receiving an “unverified” indication from hard drive 122 (“NO” branch from Step 812”), at Step 816, the control board 268 immediately reverses the stepper motor 236 in order to drive the pulltab card 114 backward and outward through proximal card slot 120. The stepper motor 236 remains active until the control board 268 stops receiving the first signal from the proximal sensor 262A, indicating that the pulltab card 114 has been fully ejected from card collector 116 and is no longer blocking the sensor's photodetector. In response, the control board 268 deactivates the stepper motor 236.

Similarly, if control board 268 fails to receive any prize-verification code from the optical scanner 260 by the time a “second” signal is triggered by the leading edge of the pulltab card 114 reaching the distal optical scanner 262B (“NO” branch from Step 808), at Step 818, control board 268 reverses the stepper motor 236 in order to drive the pulltab card 114 backward and outward through proximal card slot 120. The stepper motor 236 remains active until control board 268 stops receiving the first signal from the proximal sensor 262A, indicating that the pulltab card 114 has been fully ejected from card collector 116 and is no longer blocking the sensor's photodetector. In response, control board 268 deactivates the stepper motor 236.

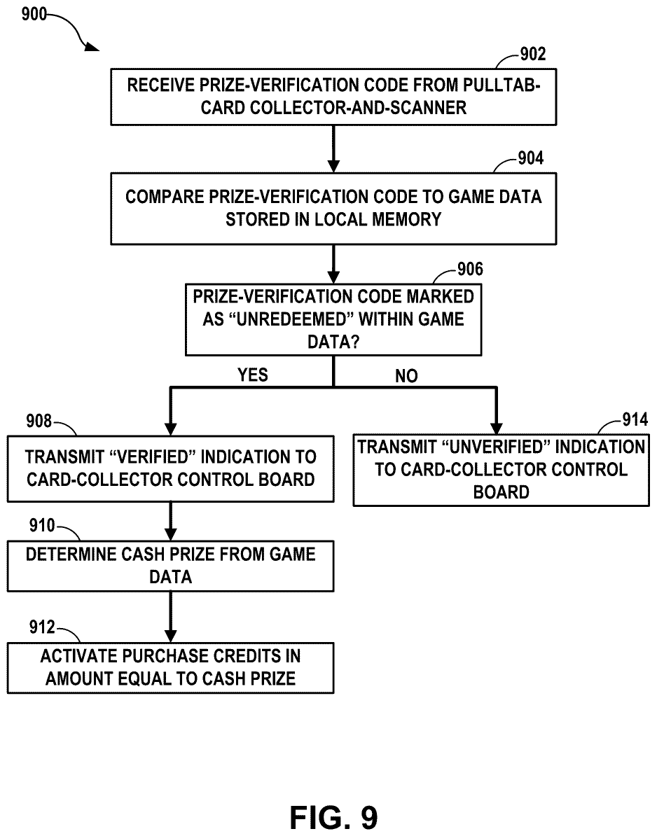

FIG. 9 is a flowchart 900 illustrating an example operation performed by the hard drive 122 of a pulltab-card vending machine 100. First, at Step 902, the hard drive 122 receives an indication of a successfully-scanned prize-verification code 388 from an integrated pulltab-card collector-and-scanner 116. At Step 904, the hard drive 122 compares the prize-verification code 388 to a set of game data 490 stored in local memory to determine (at Step 906) whether the prize-verification code 388 has a matching data entry within game data 490, and if so, whether the matching data entry indicates that the prize-verification code 388 has not already been redeemed.

Upon meeting both of these criteria (“YES” branch from Step 906), at Step 908, the hard drive 122 transmits a “Verified” signal or indication back to card collector 116, causing the card collector 116 to eject the pulltab card 114 forward into a secure receptacle 126 within vending machine 100. Additionally, at Step 910, hard drive 122 consults the matching entry within game data 490 to determine the cash prize associated with prize-verification code 388, such that, at Step 912, hard drive 122 can activate a corresponding number of credits toward the purchase of additional pulltab cards from vending machine 100.

Conversely, should either one of the verification criteria fail (“NO” branch from Step 906), at Step 914, the hard drive 122 transmits an “Unverified” signal or indication back to card collector 116, causing the card collector 116 to eject pulltab card 114 backward out of vending machine 100.

Although the systems, devices, and methods of the invention have been described in connection with the field of trading cards, card-based games, and chance-based gaming, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc., in question is (or is not) removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A non-transitory, computer-readable medium comprising program instructions that, when executed by processing circuitry of a pulltab-card collector, cause the processing circuitry to:
receive, from a proximal sensor of the pulltab-card collector, a first signal indicative of a pulltab card positioned within the proximal sensor;
responsive to receiving the first signal from the proximal sensor, activate a stepper motor to advance the pulltab card into the pulltab-card collector;
responsive to receiving the first signal from the proximal sensor, activate an optical scanner configured to scan an upper surface of the pulltab card as the stepper motor advances the pulltab card into the pulltab-card collector;
receive, from a distal sensor of the pulltab-card collector, a second signal indicative of the pulltab card positioned within the distal sensor; and
responsive to receiving the second signal from the distal sensor, deactivate the stepper motor.

2. The computer-readable medium of claim 1, wherein the processing circuitry is further configured to:
receive, from the optical scanner, a prize-verification code indicative of a scannable code printed on the pulltab card;
transmit the prize-verification code from the optical scanner to a hard drive of a pulltab-card vending machine.

3. The computer-readable medium of claim 2, wherein the processing circuitry is further configured to:
receive, from the hard drive of the pulltab-card vending machine, a “valid” signal indicating that the pulltab card is a valid, winning card;
responsive to receiving the “valid” signal, activating the stepper motor to advance the pulltab card into a secure receptacle within the pulltab-card vending machine.

4. The computer-readable medium of claim 2, wherein the processing circuitry is further configured to:
receive, from the hard drive of the pulltab-card vending machine, an “invalid” signal indicating that the pulltab card is not a valid, winning card;
responsive to receiving the “valid” signal, reversing and activating the stepper motor to eject the pulltab card outward from the pulltab-card vending machine.

5. The computer-readable medium of claim 1, wherein the processing circuitry is further configured to:
determine that a predetermined period of time has expired without receiving a prize-verification code from the optical scanner; and
responsive to the predetermined period of time expiring without receiving the prize-verification code, reversing and activating the stepper motor to eject the pulltab card outward from the pulltab-card vending machine.

6. A pulltab-card collector comprising:
a housing;
a stepper motor;
a drive belt configured to receive rotational motion from the stepper motor to draw a pulltab card into the housing;
an optical scanner;
a proximal sensor;
a distal sensor; and
processing circuitry configured to:
receive, from the proximal sensor, a first signal indicating that the a pulltab card is positioned within the proximal sensor;
responsive to receiving the first signal, activate the stepper motor to advance the pulltab card into the housing, and activate the optical scanner to scan an upper surface of the pulltab card;
receive, from the distal sensor, a second signal indicative of the pulltab card positioned within the distal sensor; and
responsive to receiving the second signal from the distal sensor, deactivate the stepper motor.

7. The pulltab-card collector of claim 6, wherein the housing comprises a left sidewall, a right sidewall, and a top wall, and wherein the top wall defines a scanning aperture.

8. The pulltab-card collector of claim 6, further comprising a scanner mounting bracket configured to retain the optical scanner at a predetermined orientation relative to the drive belt.

9. The pulltab-card collector of claim 8, wherein the predetermined orientation comprises an angle of about 50 degrees to about 70 degrees.

10. The pulltab-card collector of claim 6, wherein the drive belt comprises a pair of friction rings formed from compound WN70.

11. The pulltab-card collector of claim 6, further comprising a pair of spring-biased rollers positioned above the drive belt.

12. The pulltab-card collector of claim 6, further comprising a pair of proximal mounting brackets defining a proximal card slot therebetween.

13. The pulltab-card collector of claim 6, wherein the processing circuitry is further configured to drive the stepper motor at a reduced speed in response to receiving a first user input, and to drive the stepper motor at an increased speed in response to receiving a second user input.

14. The pulltab-card collector of claim 6, wherein the processing circuitry is further configured to:
receive a prize-verification code from the optical scanner;
transmit the prize-verification code to a hard drive of a pulltab-card vending machine;
receive a “Verified” indication signal from the hard drive of the pulltab-card vending machine; and
activate the stepper motor to advance the pulltab card into a secure receptacle.

15. The pulltab-card collector of claim 6, wherein the processing circuitry is further configured to:
receive a prize-verification code from the optical scanner;
transmit the prize-verification code to a hard drive of a pulltab-card vending machine;
receive an “Unverified” indication signal from the hard drive of the pulltab-card vending machine; and
reverse and activate the stepper motor to drive the pulltab card out from the vending machine.

16. A pulltab-card vending machine comprising:
a pulltab-card collector;
a digital memory; and
processing circuitry configured to:
receive, from the pulltab-card collector, a prize-verification code indicative of a scanned barcode printed on a pulltab card;
compare the prize-verification code to a set of game data stored in the digital memory;
locate a matching entry for the prize-verification code within the game data and confirm that the matching entry has not already been redeemed;
determine, based on the game data, a cash prize associated with the pulltab card; and
apply a number of credits toward purchasing additional pulltab cards from the vending machine in an amount corresponding to the cash prize.

17. The pulltab-card vending machine of claim 16, wherein the processing circuitry is further configured to transmit a “Verified” signal to the card collector to cause the card collector to advanced the pulltab card into a secure receptacle of the vending machine.

18. The pulltab-tab card vending machine of claim 16, wherein the pulltab-card collector comprises a drive belt and an optical scanner, and wherein the optical scanner is oriented relative to the drive belt at an angle of about 55 degrees to about 65 degrees.

19. The pulltab-card vending machine of claim 18, wherein the drive belt comprises a pair of high-friction O-rings formed from compound WN70.

20. The pulltab-card vending machine of claim 16, wherein the pulltab-card collector further comprises a pair of spring-loaded rollers positioned above the drive belt.
